(19) United States
(12) Patent Application Publication
(10) Pub. No.: US 2025/0267713 A1
(43) Pub. Date: Aug. 21, 2025

(54) CONFIGURATION AND SELECTION OF NARROWBAND PHYSICAL RANDOM ACCESS CHANNEL ORTHOGONAL COVER CODE MULTIPLEXING METHODS

(71) Applicant: Sharp Kabushiki Kaisha, Sakai City (JP)

(72) Inventors: Zhanping Yin, Vancouver, WA (US); Tomoki Yoshimura, Camas, WA (US)

(21) Appl. No.: 18/443,699

(22) Filed: Feb. 16, 2024

(51) Int. Cl. H04W 74/0833; H04J 13/00; H04W 84/06

(52) U.S. Cl. CPC H04W 74/0833; H04J 13/004; H04W 84/06

(57) ABSTRACT

An internet of things (IoT) non-terrestrial network (NTN) device user equipment (UE) is described. The UE includes receiving circuitry configured to receive narrowband physical random access channel (NPRACH) configurations including orthogonal cover code (OCC) multiplexing factors. The UE also includes transmitting circuitry configured to select an NPRACH resource and randomly select an OCC index for an OCC multiplexing. The transmitting circuitry is further configured to transmit NPRACH preambles with a configured OCC multiplexing factor.

### TECHNICAL FIELD

The present disclosure relates generally to communication systems. More specifically, the present disclosure relates to configuration and selection of Narrowband Physical Random Access Channel (NPRACH) orthogonal cover code multiplexing methods.

### BACKGROUND

Wireless communication devices have become smaller and more powerful in order to meet consumer needs and to improve portability and convenience. Consumers have become dependent upon wireless communication devices and have come to expect reliable service, expanded areas of coverage and increased functionality. A wireless communication system may provide communication for a number of wireless communication devices, each of which may be serviced by a base station. A base station may be a device that communicates with wireless communication devices.

As wireless communication devices have advanced, improvements in communication capacity, speed, flexibility and/or efficiency have been sought. However, improving communication capacity, speed, flexibility, and/or efficiency may present certain problems.

For example, wireless communication devices may communicate with one or more devices using a communication structure. However, the communication structure used may only offer limited flexibility and/or efficiency. As illustrated by this discussion, systems and methods that improve communication flexibility and/or efficiency may be beneficial.

### BRIEF DESCRIPTION OF THE DRAWINGS

FIG. 1 is a diagram illustrating an example of a non-terrestrial network (NTN) coverage area;

FIG. 2 is a diagram illustrating an example of a random access symbol group;

FIG. 3 is a table illustrating an example of random access preamble parameters for a frame structure;

FIG. 4 is a table illustrating another example of random access preamble parameters for a frame structure;

FIG. 5 is a table illustrating an example of random access baseband parameters;

FIG. 6 is a diagram illustrating an example of an NPRACH transmission with repetitions;

FIG. 7 is a diagram illustrating an example of Narrowband Internet of Things (NB-IoT) Coverage Enhancement (CE) levels;

FIG. 8 is a diagram illustrating one implementation of a core network node;

FIG. 9 is a block diagram illustrating one implementation of a base station (gNB) in which the present systems and methods may be implemented;

FIG. 10 is a block diagram illustrating one implementation of a wireless terminal in which the present systems and methods may be implemented;

FIG. 11 illustrates various components that may be utilized in a wireless terminal in which the present systems and methods may be implemented;

FIG. 12 illustrates various components that may be utilized in a gNB in which the present systems and methods may be implemented;

FIG. 13 is a block diagram illustrating one implementation of a wireless terminal in which the present systems and methods may be implemented;

FIG. 14 is a block diagram illustrating one implementation of a gNB in which the present systems and methods may be implemented;

FIG. 15 is a flow diagram illustrating an example of a method by an Internet of Things (IoT) Non-Terrestrial Network (NTN) device User Equipment (UE); and

FIG. 16 is a flow diagram illustrating an example of a method by a gNB.

### DETAILED DESCRIPTION

An internet of things (IoT) non-terrestrial network (NTN) device user equipment (UE) is described. The UE includes receiving circuitry configured to receive narrowband physical random access channel (NPRACH) configurations including orthogonal cover code (OCC) multiplexing factors. The UE also includes transmitting circuitry configured to select an NPRACH resource and randomly select an OCC index for an OCC multiplexing. The transmitting circuitry is further configured to transmit NPRACH preambles with a configured OCC multiplexing factor.

In some examples, intra repetition OCC and inter repetition OCC are configured. An intra repetition OCC multiplexing factor and an inter repetition OCC multiplexing factor may be configured separately or jointly.

In an aspect, an OCC may be first applied among random access symbol groups in each NPRACH repetition with an intra repetition multiplexing factor, and may then be applied among the NPRACH repetitions with an inter multiplexing factor over the repetitions with intra repetition OCC.

In further examples, the inter repetition OCC overrides the intra repetition OCC. The OCC may be applied among the NPRACH repetitions with an inter multiplexing factor only without performing intra repetition OCC multiplexing.

The receiving circuitry may be further configured to receive a parameter in the NPRACH configurations or in higher layer signaling to determine if the intra repetition OCC is applied together with the inter repetition OCC.

In other examples, a threshold is configured. Both the intra repetition OCC and the inter repetition OCC may be applied if a number of repetitions is smaller than the threshold. In some implementations, only the inter repetition OCC is applied if the number of repetitions is greater than or equal to the threshold.

A base station (gNB) is also described. The base station includes transmitting circuitry configured to transmit NPRACH configurations including OCC multiplexing factors. The gNB also includes receiving circuitry configured to receive and detect NPRACH preambles on NPRACH resources with a configured OCC multiplexing factor.

A method by an internet of things (IoT) non-terrestrial network (NTN) device user equipment (UE) is also described. The method includes receiving NPRACH configurations including OCC multiplexing factors. The method also includes selecting an NPRACH resource, randomly selecting an OCC index for an OCC multiplexing, and transmitting NPRACH preambles with a configured OCC multiplexing factor.

The 3rd Generation Partnership Project, also referred to as “3GPP,” is a collaboration agreement that aims to define globally applicable technical specifications and technical reports for third and fourth generation wireless communication systems. The 3GPP may define specifications for next generation mobile networks, systems and devices.

3GPP Long Term Evolution (LTE) is the name given to a project to improve the Universal Mobile Telecommunications System (UMTS) mobile phone or device standard to cope with future requirements. In one aspect, UMTS has been modified to provide support and specification for the Evolved Universal Terrestrial Radio Access (E-UTRA) and Evolved Universal Terrestrial Radio Access Network (E-UTRAN).

At least some aspects of the systems and methods disclosed herein may be described in relation to the 3GPP LTE, LTE-Advanced (LTE-A) and other standards (e.g., 3GPP Releases 8, 9, 10, 11 and/or 12). However, the scope of the present disclosure should not be limited in this regard. At least some aspects of the systems and methods disclosed herein may be utilized in other types of wireless communication systems.

A wireless communication device may be an electronic device used to communicate voice and/or data to a base station, which in turn may communicate with a network of devices (e.g., public switched telephone network (PSTN), the Internet, etc.). In describing systems and methods herein, a wireless communication device may alternatively be referred to as a mobile station, a wireless terminal, an access terminal, a subscriber station, a mobile terminal, a remote station, a user terminal, a terminal, a subscriber unit, a mobile device, etc. Examples of wireless communication devices include cellular phones, smart phones, personal digital assistants (PDAs), laptop computers, netbooks, e-readers, wireless modems, etc. In 3GPP specifications, a wireless communication device is typically referred to as a wireless terminal. However, as the scope of the present disclosure should not be limited to the 3GPP standards, the terms “wireless terminal” and “wireless communication device” may be used interchangeably herein to mean the more general term “wireless communication device.” A wireless terminal may also be more generally referred to as a terminal device.

In 3GPP specifications, a base station is typically referred to as a Node B, an evolved Node B (eNB), a home enhanced or evolved Node B (HeNB) or some other similar terminology. As the scope of the disclosure should not be limited to 3GPP standards, the terms “base station,” “Node B,” “eNB,” “gNB” and/or “HeNB” may be used interchangeably herein to mean the more general term “base station.” Furthermore, the term “base station” may be used to denote an access point. An access point may be an electronic device that provides access to a network (e.g., Local Area Network (LAN), the Internet, etc.) for wireless communication devices. The term “communication device” may be used to denote both a wireless communication device and/or a base station. An eNB may also be more generally referred to as a base station device.

It should be noted that as used herein, a “cell” may be any communication channel that is specified by standardization or regulatory bodies to be used for International Mobile Telecommunications-Advanced (IMT-Advanced) and all of it or a subset of it may be adopted by 3GPP as licensed bands (e.g., frequency bands) to be used for communication between an eNB and a wireless terminal. It should also be noted that in E-UTRA and E-UTRAN overall description, as used herein, a “cell” may be defined as “combination of downlink and optionally uplink resources.” The linking between the carrier frequency of the downlink (DL) resources and the carrier frequency of the uplink resources may be indicated in the system information transmitted on the downlink resources.

“Configured cells” are those cells of which the wireless terminal is aware and is allowed by an eNB to transmit or receive information. “Configured cell(s)” may be serving cell(s). The wireless terminal may receive system information and perform the required measurements on all configured cells. “Configured cell(s)” for a radio connection may include a primary cell and/or no, one, or more secondary cell(s). “Activated cells” are those configured cells on which the wireless terminal is transmitting and receiving. That is, activated cells are those cells for which the wireless terminal monitors the physical downlink control channel (PDCCH) and in the case of a downlink transmission, those cells for which the wireless terminal decodes a physical downlink shared channel (PDSCH). “Deactivated cells” are those configured cells that the wireless terminal is not monitoring the transmission PDCCH. It should be noted that a “cell” may be described in terms of differing dimensions. For example, a “cell” may have temporal, spatial (e.g., geographical) and frequency characteristics.

Fifth generation (5G) cellular communications (also referred to as “New Radio,” “New Radio Access Technology” or “NR” by 3GPP) envisions the use of time, frequency and/or space resources to allow for enhanced mobile broadband (eMBB) communication and ultra-reliable low-latency communication (URLLC) services, as well as massive machine type communication (MMTC) like services. To meet a latency target and high reliability, mini-slot-based repetitions with flexible transmission occasions may be supported. Approaches for applying mini-slot-based repetitions are described herein. A new radio (NR) base station may be referred to as a gNB. A gNB may also be more generally referred to as a base station device.

One important objective of 5G is to enable connected industries. 5G connectivity can serve as a catalyst for the next wave of industrial transformation and digitalization, which improve flexibility, enhance productivity and efficiency, reduce maintenance cost, and improve operational safety. Devices in such environments may include, for example, pressure sensors, humidity sensors, thermometers, motion sensors, accelerometers, actuators, etc. It is desirable to connect these sensors and actuators to 5G networks and core. The massive industrial wireless sensor network (IWSN) use cases and requirements include not only URLLC services with very high requirements, but also relatively low-end services with the requirement of small device form factors, and/or being completely wireless with a battery life of several years. The requirements for these services that are higher than low power wide area (LPWA) (e.g., LTE-MTC and/or Narrowband Internet of Things (LTE-M/NB-IoT)) but lower than URLLC and eMBB.

A non-terrestrial network (NTN) refers to a network, or segment of networks using radio frequency (RF) resources onboard a satellite (or UAS platform). Non-Terrestrial Network typically features the following elements: one or several sat-gateways that connect the Non-Terrestrial Network to a public data network. For example, a Geostationary Earth Orbiting (GEO) satellite is fed by one or several sat-gateways which are deployed across the satellite targeted coverage (e.g., regional or even continental coverage). It may be assumed that wireless terminals in a cell are served by only one sat-gateway. A Non-GEO satellite served successively by one or several sat-gateways at a time. The system ensures service and feeder link continuity between the successive serving sat-gateways with sufficient time duration to proceed with mobility anchoring and hand-over.

Additionally, Non-Terrestrial Network typically features the following elements: a Feeder link or radio link between a sat-gateway and the satellite (or Unmanned Aircraft System (UAS) platform), a service link or radio link between the wireless terminal and the satellite (or UAS platform).

Additionally, Non-Terrestrial Network typically features the following elements: a satellite (or UAS platform) which may implement either a transparent or a regenerative (with onboard processing) payload. The satellite (or Unmanned Aircraft System (UAS) platform) may generate several beams over a given service area bounded by its field of view. The footprints of the beams are typically of elliptic shape. The field of view of a satellite (or UAS platform) depends on the onboard antenna diagram and min elevation angle. For a transparent payload, radio frequency filtering, frequency conversion and amplification may be applied. Hence, the waveform signal repeated by the payload is un-changed. For a regenerative payload, radio frequency filtering, frequency conversion and amplification as well as demodulation/decoding, switch and/or routing, coding/modulation may be applied. This is effectively equivalent to having all or part of base station functions (e.g., gNB) onboard the satellite (or UAS platform).

Additionally, Non-Terrestrial Network may optionally feature the following elements: Inter-satellite links (ISL) optionally in case of a constellation of satellites. This will require regenerative payloads onboard the satellites. ISL may operate in RF frequency or optical bands.

Additionally, Non-Terrestrial Network typically features the following elements: User Equipment may be served by the satellite (or UAS platform) within the targeted service area.

There may be different types of satellites (or UAS platforms): Low-Earth Orbit (LEO) satellite, Medium-Earth Orbit (MEO) satellite, Geostationary Earth Orbit (GEO) satellite, UAS platform (including High-Altitude Platform Station (HAPS) and High Elliptical Orbit (HEO) satellite). Detailed descriptions are shown in Table 1.

TABLE 1

| | | | | Typical beam | |
|---|---|---|---|---|---|
| Platforms | Altitude range | | Orbit | footprint size | |
| Low-Earth Orbit | 300-1500 | km | Circular around the earth | 100-1000 | km |
| (LEO) satellite | | | | | |
| Medium-Earth Orbit | 7000-25000 | km | | 100-1000 | km |
| (MEO) satellite | | | | | |
| Geostationary Earth | 35 786 | km | Notional station keeping | 200-3500 | km |
| Orbit (GEO) satellite | | | position fixed in terms | | |
| UAS platform | 8-50 | km | of elevation/azimuth with | 5-200 | km |
| (including HAPS) | (20 km for HAPS) | | respect to a given earth | | |
| | | | point | | |
| High Elliptical Orbit | 400-50000 | km | Elliptical around the earth | 200-3500 | km |
| (HEO) satellite | | | | | |

Typically, GEO satellites and UAS are used to provide continental, regional or local service. A constellation of LEO and MEO may be used to provide services in both Northern and Southern hemispheres. In some cases, the constellation can even provide global coverage including polar regions. For the later, this requires appropriate orbit inclination, sufficient beams generated and inter-satellite links.

Non-terrestrial networks may provide access to wireless terminal in six reference scenarios including: Circular orbiting and notional station keeping platforms, highest round trip delay (RTD) constraint, highest Doppler constraint, a transparent and a regenerative payload, one ISL case and one without ISL (Regenerative payload is mandatory in the case of inter-satellite links), fixed or steerable beams resulting respectively in moving or fixed beam foot print on the ground.

The systems and methods described herein may be used to address the need of NTN Internet of Things (IoT) NPRACH multiplexing with an Orthogonal Cover Code (OCC):
The NTN link may be a long distance, and the signal may be weak, thus, more repetitions may be needed for an NPRACH preamble transmission.
The NTN may have a very large coverage area, and the number of IoT devices in the coverage area may be vary large.
Collision of NPRACH preambles between NTN IoT device may occur more frequently.
   NPRACH Preamble Transmissions with Orthogonal Cover Code Multiplexing in IoT NTN

IoT NTN User Equipment (UE) uses legacy methods for NPRACH resource selection, preamble format determination and sequence generation, etc. If OCC is configured, the UE will pick an OCC index randomly in the set of OCC codes, and apply to the Physical Random Access Channel (PRACH) preamble sequences by multiplication.

The base station configures the OCC multiplexing method and the OCC multiplexing factor in NPRACH configurations for Narrowband Internet of Things (NB-IoT). The base station detects the NPRACH sequences by hypothesis tests with all OCC codes, and finds whether one or more NPRACH preamble(s) is(are) received. The base station determines the NPRACH index(s) and the OCC index(s) if NPRACH preamble(s) is(are) detected.

Several OCC multiplexing methods may be considered.

### Method 1: Intra Repetition OCC Multiplexing Only, Type 1 OCC

OCC is applied among the random access symbol groups in a repetition, also known as inner OCC, inner multiplexing, intra-NPRACH-multiplexing, and intra-Repetition-multiplexing, etc.

The total number of symbol groups in a preamble repetition unit is denoted by P. The multiplexing capability of intra repetition multiplexing is determined by the value P, e.g. the maximum spreading factor of 4 OCC for the 4 access symbol groups in a repetition for preamble format 0 and format 1.

### Method 2: Inter Repetition OCC Multiplexing Only, Type 2 OCC

OCC is applied among the NPRACH preamble repetitions. This method can be named as outer-OCC, outer-multiplexing, inter-Repetition-OCC, and inter-Repetition-multiplexing, etc.

The OCC code is applied on each preamble repetition. The inter repetition OCC multiplexing factor can be configured, e.g. 2, 4, 8, 16, and 32, etc. The inter repetition OCC multiplexing factor is not higher than the configured number of repetitions numRepetitionsPerPreambleAttempt. A larger number of multiplexing factor may be configured for larger repetition factors to reduce the collision probability.

Method 3: OCC Multiplexing on Symbol Groups within and Across Repetitions, Type 3 OCC

OCC is applied among the random access symbol groups in one or more repetitions. The OCC multiplexing factor can be configured with at least 4, e.g. 4, 8, 16, or 32, etc. Depending on the configured OCC multiplexing factor, an OCC can extend to multiple repetitions. The multiplexing factor cannot be higher than the multiplication of the number of repetitions and the number of symbol groups in a repetition.

### Method 4: Combination of Intra Repetition and Inter Repetition OCC, Type 4 OCC

The intra repetition OCC and inter repetition OCC can be configured and applied independently or jointly. The intra repetition OCC multiplexing factor and inter repetition OCC factor can be configured separately or jointly.

If both intra repetition OCC and inter repetition OCC are configured:
Approach 1: the resulting multiplexing capacity or multiplexing factor is determined by the multiplication of the intra repetition OCC multiplexing factor and the inter repetition OCC multiplexing factor.
   Intra repetition OCC is applied first on symbol groups in a repetition.
   Inter repetition OCC is applied over the repetitions with intra repetition OCC.
   May potentially support higher multiplexing capacity especially when the number of repetitions is small.
Approach 2: the inter repetition OCC overrides the intra repetition OCC.
   If inter repetition OCC multiplexing is configured, intra repetition OCC multiplexing is disabled even if it is configured.
   Limited multiplexing capabilities when the number of repetitions is small.
Whether to use Approach 1 or Approach 2 may be configured by a parameter in NPRACH configuration or with a higher layer signaling. Alternatively, whether to use Approach 1 or Approach 2 may be determined by the number of NPRACH preamble repetitions and/or coverage enhancement (CE) level.

The OCC methods may be applied to Transport Network (TN) NB-IoT UEs as well. If so, both intra repetition OCC and inter repetition OCC should be supported. For different coverage enhancement levels, intra repetition OCC is more suitable for low Coverage Enhancement (CE) level with no repetition or very small number of repetitions.

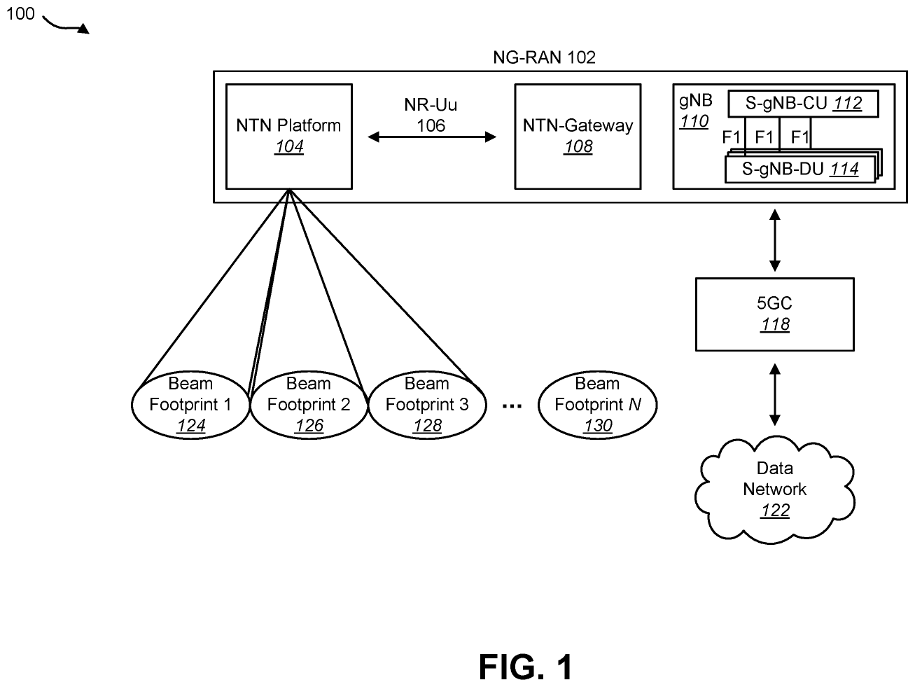

FIG. 1 is a diagram 100 illustrating an example 100 of a non-terrestrial network (NTN) coverage area with a plurality of beams. The Next Generation Radio Access Network (NG-RAN) 102 includes an NTN-Platform 104 in communication with an NTN-Gateway 108 through a 5G air interface, such an NR-Uu 106 (New Radio User Equipment (UE) to the NR Node B (gNB) radio interface). The NG-RAN 102 also includes a base station device (gNB) 110. The gNB 110 includes an S-gNB-CU (Secondary gNodeB Control Unit) 112 and an S-gNB-DU (Secondary gNodeB Distributed Unit) 114 in communication with each unit via F1 interfaces.

The NTN coverage area includes a plurality of beams having footprints: beam footprints 1, 2, 3, . . . N (124, 126, 128, 130). The 5G Core network (5GC) 118 is in communication with the NG-RAN 102 and a data network 122, such as a global communications network or other data network.

### A. IoT-NTN Study on Uplink Enhancement

Need for Uplink capacity enhancement: NB-IoT NTN is currently being used. In these early and upcoming deployments, it is emerging that IoT-NTN, in particular NB-IoT, will have to support massive capacity in terms of number and types of UEs, some of which will have worse characteristics than others (e.g. low cost devices, wearables, etc.). Multiplexing of UEs by usage of orthogonal cover codes (OCC) for Narrowband Physical Uplink Shared Channel (NPUSCH) format 1 and NPRACH should therefore be studied, and if beneficial be specified and utilized. Therefore, in order to unlock the additional Uplink (UL) capacity potential, there is a need to identify methods to de-couple the UL from the Downlink (DL) as much as possible.

For the support of capacity enhancements for uplink, the aim is to study then specify, if beneficial, enhancements to enable multiplexing of multiple UEs (e.g. up to the minimum of 4 and the maximum allowed by the existing UL and DL signaling) in a single 3.75 kilohertz (kHz) or 15 kHz subcarrier via orthogonal cover codes (OCC) for NPUSCH format 1 and NPRACH.

### B. NPRACH for NB-IoT

For NB-IoT frame structure, frame structure type 1 is applicable to Frequency Division Duplexing (FDD) operation only, and frame structure type 2 is applicable to Time Division Duplexing (TDD) operation only.

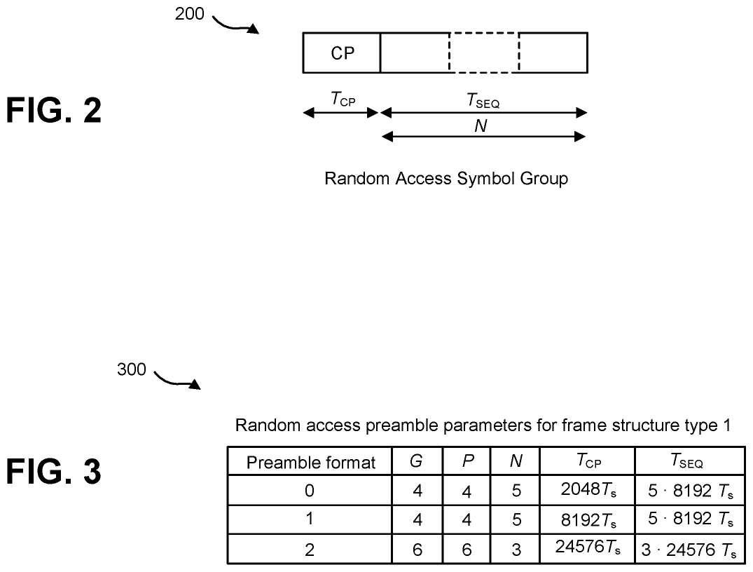

FIG. 2 is a diagram 200 of an example of a random access symbol group which is used by a UE to gain access to the network.

FIG. 3 is a table 300 of an example of random access preamble parameters for frame structure type 1.

The physical layer random access preamble is based on single-subcarrier frequency-hopping symbol groups. A symbol group is illustrated in FIGS. 2-3, comprised of a cyclic prefix (CP) of length r, and a sequence of N identical symbols with total length T_{SEQ}. The total number of symbol groups in a preamble repetition unit is denoted by P. The number of time-contiguous symbol groups is given by G.

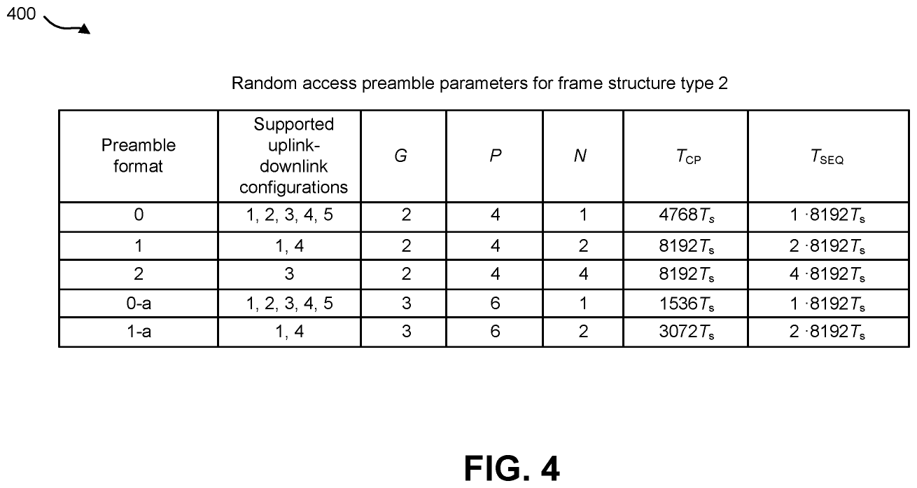

The parameter values for frame structures 1 and 2 are listed in FIGS. 3-4, respectively.

FIG. 4 is a table 400 illustrating an example of random access preamble parameters for frame structure type 2. Various examples of preamble formats, configurations, symbol groups, CP lengths and total lengths are shown.

The preamble consisting of P symbol groups shall be transmitted Nᵣₑₚ^{NPRACH} times. For frame structure type 2, when an invalid uplink subframe overlaps the transmission of G symbol groups without a gap, the G symbol groups are dropped. For frame structure type 2, the transmission of G symbol groups are aligned with the subframe boundary.

The transmission of a random-access preamble, if triggered by the Medium Access Control (MAC) layer, is restricted to certain time and frequency resources.

A NPRACH configuration provided by higher layers contains the following:
NPRACH resource periodicity N_{period}^{NPRACH} (nprach-Periodicity).
Frequency location of the first subcarrier allocated to NPRACH N_{scoffset} ^{NPRACH} (nprach-SubcarrierOffset).
Number of subcarriers allocated to NPRACH N_{sc}^{NPRACH} (nprach-NumSubcarriers).
Number of starting sub-carriers allocated to UE initiated random access N_{sc_cont}^{NPRACH} (nprach-NumCBRA-StartSubcarriers).
Number of NPRACH repetitions per attempt Nᵣₑₚ^{NPRACH} (numRepetitionsPerPreambleAttempt).
NPRACH starting time Nₛₜₐᵣₜ^{NPRACH} (nprach-StartTime).
Fraction for calculating starting subcarrier index for the range of NPRACH subcarriers reserved for indication of UE support for multi-tone msg3 transmission N_{MSG3}^{NPRACH} (nprach-SubcarrierMSG3-RangeStart).

An NPRACH transmission can start only Nₛₜₐᵣₜ^{NPRACH}·30720Tₛ time units after the start of a radio frame fulfilling n_{f} mod(N_{period}^{NPRACH}/10)=0. For frame structure type 1, after transmissions of 4·64(T_{CP}+T_{SEQ}) time units for preamble formats 0 and 1, or 16·6(T_{CP}+T_{SEQ}) time units for preamble format 2, a gap of 40·30720 Tₛ time units shall be inserted.

NPRACH configurations where N_{scoffset}^{NPRACH}+N_{sc}^{NPRACH}>N_{sc}^{UL} are invalid.

The NPRACH starting subcarriers allocated to UE initiated random access are split in two sets of subcarriers, {0,1, . . . , └N_{sc_cont}^{NPRACH} N_{MSG3}^{NPRACH}┘−1} and {└N_{sc_cont}^{NPRACH} N_{MSG3}^{NPRACH}┘, . . . , N_{sc_cont}^{NPRACH}−1}, where the second set, if present, indicates UE support for a multi-tone msg3 transmission.

The frequency location of the NPRACH transmission is constrained within N_{sc}^{RA}=12 sub-carriers, and within N_{sc}^{RA}=36 subcarriers when preamble format 2 as described in FIG. 2 is configured. Frequency hopping shall be used within the 12 subcarriers and 36 subcarriers when preamble format 2 as described in FIG. 2 is configured, where the frequency location of the i^{th} symbol group is given by n_{sc}^{RA} (i)=nₛₜₐᵣₜ+ñ_{SC}^{RA}(i) where nₛₜₐᵣₜ=N_{scoffset}^{NPRACH}+└nᵢₙᵢₜ/N_{sc}^{RA}┘·N_{sc}^{RA}. The quantity ñ_{sc}^{RA}(i) depends on the frame structure.

For frame structure type 1:
if G=4, P=4 for preamble formats 0 and 1 as described in FIG. 2:

$${\tilde{n}}_{s c}^{R A} ( i ) = \{ \begin{matrix}( {\tilde{n}}_{sc}^{RA} ( 0 ) + f ( i / 4 ) mod {N}_{sc}^{RA} & i mod 4 = 0 and i > 0 \\ {\tilde{n}}_{sc}^{RA} ( i - 1 ) + 1 & i mod 4 = 1 , 3 and {\tilde{n}}_{sc}^{RA} ( i - 1 ) mod 2 = 0 \\ {\tilde{n}}_{sc}^{RA} ( i - 1 ) - 1 & i mod 4 = 1 , 3 and {\tilde{n}}_{sc}^{RA} ( i - 1 ) mod 2 = 1 \\ {\tilde{n}}_{sc}^{RA} ( i - 1 ) + 6 & i mod 4 = 2 and {\tilde{n}}_{sc}^{RA} ( i - 1 ) < 6 \\ {\tilde{n}}_{sc}^{RA} ( i - 1 ) - 1 & i mod 4 = 2 and {\tilde{n}}_{sc}^{RA} ( i - 1 ) \geq 6\end{matrix}$$

$$f ( t ) = ( f ( t - 1 ) + ( {{\sum }_{n = 10 t + 1}}^{10 t + 9} c ( n ) {2}^{n - ( 10 t + 1 )} ) mod ( {N}_{s c}^{R A} - 1 ) + 1 ) mod {N}_{sc}^{R A}$$

$$f ( - 1 ) = 0$$

Where ñ_{SC}^{RA}(0)=nᵢₙᵢₜ modN_{sc}^{RA} with nᵢₙᵢₜ being the subcarrier selected by the MAC layer from {0,1, . . . , N_{sc}^{NPRACH}−1}, and the pseudo random sequence c(n) is given in the related specifications. The pseudo random sequence generator shall be initialized with cᵢₙᵢₜ=N_{ID}^{Ncell}.
if G=6, P=6 for preamble format 2 as described in FIG. 2:

$${n}_{SC}^{RA} ( i ) = \{ \begin{matrix}( {\tilde{n}}_{SC}^{RA} ( 0 ) + f ( i / 6 ) ) mod {N}_{sc}^{RA} & i mod 6 = 0 and i > 0 \\ {\tilde{n}}_{SC}^{RA} ( i - 1 ) + 1 & i mod 6 = 1 , 5 and {\tilde{n}}_{SC}^{RA} ( i - 1 ) mod 2 = 0 \\ {\tilde{n}}_{SC}^{RA} ( i - 1 ) - 1 & i mod 6 = 1 , 5 and {\tilde{n}}_{SC}^{RA} ( i - 1 ) mod 2 = 0 \\ {\tilde{n}}_{SC}^{RA} ( i - 1 ) + 3 & i mod 6 = 2 , 4 and ⌊ {\tilde{n}}_{SC}^{RA} ( i - 1 ) / 3 ⌋ mod 2 = 0 \\ {\tilde{n}}_{SC}^{RA} ( i - 1 ) - 3 & i mod 6 = 2 , 4 and ⌊ {\tilde{n}}_{SC}^{RA} ( i - 1 ) / 3 ⌋ mod 2 = 1 \\ {\tilde{n}}_{SC}^{RA} ( i - 1 ) + 18 & i mod 6 = 3 and {\tilde{n}}_{SC}^{RA} ( i - 1 ) < 18 \\ {\tilde{n}}_{SC}^{RA} ( i - 1 ) - 18 & i mod 6 = 3 and {\tilde{n}}_{SC}^{RA} ( i - 1 ) \geq 18\end{matrix}$$

$$f ( t ) = ( f ( t - 1 ) + ( {{\sum }_{n = 10 t + 1}}^{10 t + 9} c ( n ) {2}^{n - ( 10 t + 1 )} ) mod ( {N}_{s c}^{R A} - 1 ) + 1 ) mod {N}_{sc}^{R A}$$

$$f ( - 1 ) = 0$$

Where ñ_{SC}^{RA}(0)=nᵢₙᵢₜ modN_{sc}^{RA} with nᵢₙᵢₜ being the subcarrier selected by the MAC layer from {0,1, . . . , N_{sc}^{NPRACH}−1}, and the pseudo random sequence c(n) is given in the related specifications. The pseudo random sequence generator shall be initialized with cᵢₙᵢₜ=N_{ID}^{Ncell}.

For frame structure type 2:
if G=2, P=4 for preamble formats 0, 1, and 2 as described in FIG. 4:

$${\tilde{n}}_{SC}^{RA} = \{ \begin{matrix}Y & i mod 8 = 0 , 2 and i > 0 \\ {\tilde{n}}_{SC}^{RA} ( i - 1 ) + 1 & i mod 8 = 1 and {\tilde{n}}_{SC}^{RA} ( i - 1 ) = 0 , 2 , 4 , 6 , 8 , 10 \\ {\tilde{n}}_{SC}^{RA} ( i - 1 ) - 1 & i mod 8 = 1 and {\tilde{n}}_{SC}^{RA} ( i - 1 ) = 1 , 3 , 5 , 7 , 9 , 11 \\ {\tilde{n}}_{SC}^{RA} ( i - 1 ) + 6 & i mod 8 = 3 and {\tilde{n}}_{SC}^{RA} ( i - 1 ) = 0 , 1 , 2 , 3 , 4 , 5 \\ {\tilde{n}}_{SC}^{RA} ( i - 1 ) - 6 & i mod 8 = 3 and {\tilde{n}}_{SC}^{RA} ( i - 1 ) = 6 , 7 , 8 , 9 , 10 , 11 \\ 2 ⌊ \frac{Y}{2} ⌋ + 1 & i mod 8 = 4 and {\tilde{n}}_{SC}^{RA} ( i - 4 ) = 0 , 2 , 4 , 6 , 8 , 10 \\ 2 ⌊ \frac{Y}{2} ⌋ & i mod 8 = 4 and {\tilde{n}}_{SC}^{RA} ( i - 4 ) = 1 , 3 , 5 , 7 , 9 , 11 \\ {\tilde{n}}_{SC}^{RA} ( i - 1 ) - 1 & i mod 8 = 5 and {\tilde{n}}_{SC}^{RA} ( i - 1 ) = 1 , 3 , 5 , 7 , 9 , 11 \\ {\tilde{n}}_{SC}^{RA} ( i - 1 ) + 1 & i mod 8 = 5 and {\tilde{n}}_{SC}^{RA} ( i - 1 ) = 0 , 2 , 4 , 6 , 8 , 10 \\ Y mod 6 + 6 & i mod 8 = 6 and {\tilde{n}}_{SC}^{RA} ( i - 4 ) = 0 , 1 , 2 , 3 , 4 , 5 \\ Y mod 6 & i mod 8 = 6 and {\tilde{n}}_{SC}^{RA} ( i - 4 ) = 6 , 7 , 8 , 9 , 10 , 11 \\ {\tilde{n}}_{SC}^{RA} ( i - 1 ) - 6 & i mod 8 = 7 and {\tilde{n}}_{SC}^{RA} ( i - 1 ) = 6 , 7 , 8 , 9 , 10 , 11 \\ {\tilde{n}}_{SC}^{RA} ( i - 1 ) + 6 & i mod 8 = 7 and {\tilde{n}}_{SC}^{RA} ( i - 1 ) = 0 , 1 , 2 , 3 , 4 , 5\end{matrix}$$

$$Y = ( {\tilde{n}}_{SC}^{RA} ( 0 ( + f ( i / 2 ) ) mod {N}_{sc}^{RA}$$

$$f ( t ) = ( f ( t - 1 ) + ( {\sum }_{n = 10 t + 1}^{10 t + 9} c ( n ) {2}^{n - ( 10 t + 1 )} ) mod ( {N}_{s c}^{R A} - 1 ) + 1 ) mod {N}_{sc}^{R A}$$

$$f ( - 1 ) = 0$$

Where ñ_{SC}^{RA}(0)=nᵢₙᵢₜ modN_{sc}^{RA} with nᵢₙᵢₜ being the subcarrier selected by the MAC layer from {0,1, . . . , N_{sc}^{NPRACH}−1}, and the pseudo random sequence c(n) is given in the related specifications. The pseudo random sequence generator shall be initialised with cᵢₙᵢₜ=N_{ID}^{Ncell}.
if G=3, P=6 for preamble formats 0-a, 1-a, as described in FIG. 4:

$${\tilde{n}}_{SC}^{RA} ( i ) = \{ \begin{matrix}( {\tilde{n}}_{SC}^{RA} ( 0 ) + f ( i / 3 ) ) mod {N}_{sc}^{RA} & i mod 6 = 0 , 3 and i > 0 \\ {\tilde{n}}_{SC}^{RA} ( i - 1 ) + 1 & i mod 6 = 1 and {\tilde{n}}_{SC}^{RA} ( i - 1 ) = 0 , 2 , 4 , 6 , 8 , 10 \\ {\tilde{n}}_{SC}^{RA} ( i - 1 ) - 1 & i mod 6 = 2 and {\tilde{n}}_{SC}^{RA} ( i - 2 ) = 0 , 2 , 4 , 6 , 8 , 10 \\ {\tilde{n}}_{SC}^{RA} ( i - 1 ) - 1 & i mod 6 = 1 and {\tilde{n}}_{SC}^{RA} ( i - 1 ) = 1 , 3 , 5 , 7 , 9 , 11 \\ {\tilde{n}}_{SC}^{RA} ( i - 1 ) + 1 & i mod 6 = 2 and {\tilde{n}}_{SC}^{RA} ( i - 2 ) = 1 , 3 , 5 , 7 , 9 , 11 \\ {\tilde{n}}_{SC}^{RA} ( i - 1 ) + 6 & i mod 6 = 4 and {\tilde{n}}_{SC}^{RA} ( i - 1 ) = 0 , 1 , 2 , 3 , 4 , 5 \\ {\tilde{n}}_{SC}^{RA} ( i - 1 ) - 6 & i mod 6 = 5 and {\tilde{n}}_{SC}^{RA} ( i - 2 ) = 0 , 1 , 2 , 3 , 4 , 5 \\ {\tilde{n}}_{SC}^{RA} ( i - 1 ) - 6 & i mod 6 = 4 and {\tilde{n}}_{SC}^{RA} ( i - 1 ) = 6 , 7 , 8 , 9 , 10 , 11 \\ {\tilde{n}}_{SC}^{RA} ( i - 1 ) + 6 & i mod 6 = 5 and {\tilde{n}}_{SC}^{RA} ( i - 2 ) = 6 , 7 , 8 , 9 , 10 , 11\end{matrix}$$

$$f ( t ) = ( f ( t - 1 ) + ( {\sum }_{n = 10 t + 1}^{10 t + 9} c ( n ) {2}^{n - ( 10 t + 1 )} ) mod ( {N}_{s c}^{R A} - 1 ) + 1 ) mod {N}_{sc}^{R A}$$

$$f ( - 1 ) = 0$$

Where ñ_{SC}^{RA}(0)=nᵢₙᵢₜ modN_{sc}^{RA} with nᵢₙᵢₜ being the subcarrier selected by the MAC layer from {0,1, . . . , N_{sc}^{NPRACH}−1}, and the pseudo random sequence c(n) is given in the related specifications. The pseudo random sequence generator shall be initialised with cᵢₙᵢₜ=N_{ID}^{Ncell}.

### Baseband Signal Generation

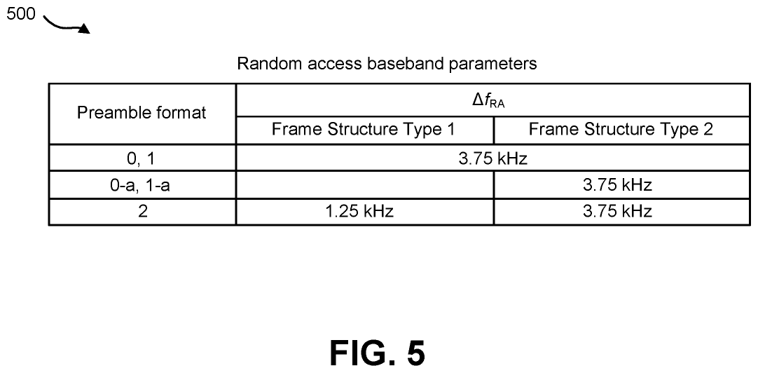

The time-continuous random-access signal sᵢ(t) for symbol group i is defined by:

$${s}_{i} ( t ) = {β}_{N P R A C H} {e}^{j 2 π ( {n}_{S C}^{R A} ( i ) + K {k}_{0} + 1 / 2 ) Δ {f}_{R A} ( f - {T}_{C P} )}$$

Where 0≤t≤T_{SEQ}+T_{CP}, β_{NPRACH} is an amplitude scaling factor in order to conform to the transmit power P_{NPRACH}, k₀=−N_{sc}^{UL}/2, K=Δf/Δf_{RA} accounts for the difference in subcarrier spacing between the random access preamble and uplink data transmission, and the location in the frequency domain controlled by the parameter n_{SC}^{RA}(i) is derived in the related specifications. The variable Δf_{RA} is given by FIG. 5.

FIG. 5 is a table 500 illustrating an example of random access baseband parameters. FIG. 5 illustrates various preamble formats and the variable Δf_{RA}.

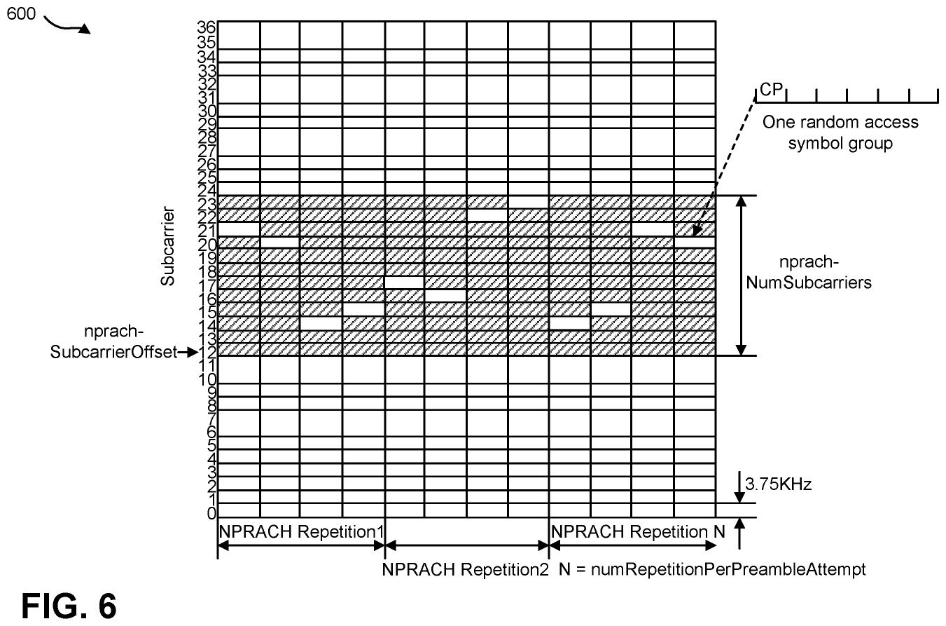

FIG. 6 is a diagram 600 showing an example of an NPRACH transmission with frame structure type 1 with preamble format 0 or format 1. As shown in FIG. 6, each NPRACH repetition consists of P=4 random access symbol groups, where a symbol group with a Cyclic Prefix (CP) and N=5 symbols. The hopping rule is given by ñ_{sc}^{RA}(i) above. The NPRACH is repeated until the number of NPRACH repetitions per attempt Nᵣₑₚ^{NPRACH} (numRepetitionsPerPreambleAttempt) is reached.

### Coverage Enhancement (CE) Levels

The NB-IoT standard supports three so-called Coverage Enhancement (CE)-Levels to address the different radio conditions, based on reference signal receive power (RSRP) thresholds. The value of the RSRP is computed in the NB-IoT UE devices by averaging the received power over the Resource Elements (REs) carrying the New Radio Synchronization (NRS) within the considered NB-IoT bandwidth. Each CE Level determines the number of times downlink and uplink messages can be repeated to reach devices in poor coverage and the number of repetitions in each CE-Level is predefined by the network.

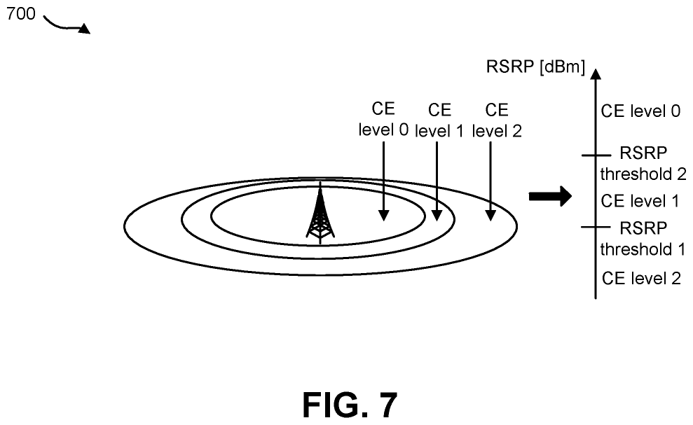

In NB-IoT, two RSRP thresholds can be defined per cell; thus, there are at most three CE levels, as shown in FIG. 7. FIG. 7 is a diagram 700 illustrating an example of NB-IoT CE levels. Every UE in the NB-IoT cell computes its RSRP level and then, depending on the obtained value, selects the corresponding CE level according to the defined RSRP thresholds. Due to the long distances satellite links, the IoT NTN devices are most likely in the high CE level.

Most of the essential information about the NB-IoT cells are transmitted in SIB2-NB. This includes the information on the RSRP thresholds and the parameters of NPRACH scheduling. A separate NPRACH configuration is configured for each CE level (i.e., in case RSRP thresholds are included in SIB2-NB). The parameters of each CE level are configured separately. An NB-IoT UE applies a different configuration for NPRACH transmissions according to its CE level (e.g., different number of repetitions, frequency location, etc.).

In general, the NPRACH occasions of different CE levels should not overlap in frequency and time domain. Thus, the NPRACH parameters dedicated to each CE level can take different values while respecting several constraints defined by 3GPP. For example, the number of repetition parameters should be different in each CE level and the values should be in increasing order, i.e., the Nᵣₑₚ^{NPRACH} of CE2 is bigger than the one for CE1 and CE0.

C. NPRACH Multiplexing with Orthogonal Cover Code (OCC)

Compared with a terrestrial network (TN), an NTN link with satellite forwarding has a longer distance and a weaker signal. Thus, more repetitions may be needed for PRACH preamble transmissions. Furthermore, an NTN satellite has a very large coverage area, and the number of NB-IoT devices in the coverage area can be very large. Thus, for a given NPRACH configuration, the collision of PRACH preambles between NTN IoT devices may occur more frequently. Therefore, multiplexing with orthogonal cover code (OCC) is highly desirable, and can bring significant system performance enhancements on random access capacity.

Several methods of OCC multiplexing can be considered. The multiplexing capability of an OCC is also known as OCC length, OCC spreading factor, the multiplexing factor, and OCC multiplexing capability, etc.

### Method 1: Intra Repetition OCC Multiplexing Only, Type 1 OCC

In one method, OCC is applied among the random access symbol groups in a NPRACH repetition. This method can be named as inner-OCC, inner-multiplexing, intra-Repetition-OCC, or intra-Repetition-multiplexing, etc. The total number of symbol groups in a preamble repetition unit is denoted by P. Thus, the multiplexing capability of intra-Repetition-multiplexing is determined by the value P.

Thus, for preamble format 0 and format 1, OCC multiplexing factor of 4 can be applied on the 4 random access symbol groups in a NPRACH repetition. A sample OCC code is given as [+1, +1, +1, +1][+1, −j, −1, +j][+1, −1, +1, −1][+1, +j, −1, −j] for OCC multiplexing factor of 4. Also, OCC multiplexing factor of 2 can be configured on the 4 random access symbol groups in a NPRACH repetition. A sample OCC code is given as [+1, +1][+1, −1] for OCC multiplexing a factor of 2.

For preamble format 2, up to a OCC multiplexing factor of 6 can be achieved, although it is possible to support only a OCC multiplexing factor of 4.

With method 1, the multiplexing factor is fixed and limited by the number of symbol groups in each NPRACH repetition, e.g., can only support up to 4×OCC for NPRACH format 0 and format 1. Method 1 is easier for OCC to apply on each basic structure for NPRACH transmissions, and can be shared with NB-IoT devices with different repetition factors.

For an IoT NTN device, the legacy methods are used to determine the NPRACH resource, NPRACH format, and preamble sequence generation, etc. If intra repetition OCC is configured, the UE will pick an OCC index randomly in the set of OCC codes, and apply to the symbol groups in each NPRACH repetition. Each entry in an OCC index is applied on a symbol group by bit-width multiplication with the sequence. For example, for an OCC factor of 4 and a selected OCC code index 2 with [+1, −j, −1, +j], the symbol groups in a repetition [symgroup0, symgroup1, symgroup2, symgroup3] is multiplexed with the OCC indexes and the resulting output is given by [symgroup0, −j*symgroup1, −symgroup2, j*symgroup3]. The same selected OCC is applied in all repetitions of the NPRACH transmissions.

The OCC multiplexing may be extended to TN NB-IoT. The intra repetition OCC may be very useful to provide multiplexing capabilities for TN NB-IoT, especially for devices with a very small number of NPRACH repetitions, and/or with a low CE level.

### Method 2: Inter Repetition OCC Multiplexing Only, Type 2 OCC

In another method, OCC is applied among the preamble repetitions. This method can be named as outer-OCC, outer-multiplexing, inter-Repetition-OCC, or inter-Repetition-multiplexing, etc. The preamble consisting of P symbol groups shall be transmitted Nᵣₑₚ^{NPRACH} times. Thus, the multiplexing capability of intra-Repetition-multiplexing is determined by the parameter Nᵣₑₚ^{NPRACH}

The inter repetition OCC multiplexing factor can be configured, e.g. 2, 4, 8, 16, and 32, etc. The OCC multiplexing factor can be longer depending on the number of repetition parameters as long as the inter repetition OCC multiplexing factor is not higher than the configured number of repetitions numRepetitionsPerPreambleAttempt. A larger number of multiplexing factors should be configured for larger repetition factors to reduce the collision probability.

The values of numRepetitionsPerPreambleAttempt is ENUMERATED {n1, n2, n4, n8, n16, n32, n64, n128}. For example, if a maximum OCC multiplexing factor of 32 is supported, the following OCC multiplexing factors can be configured for different values of numRepetitionsPerPreambleAttempt.
numRepetitionsPerPreambleAttempt=n1, no OCC
numRepetitionsPerPreambleAttempt=n2, support 2×OCC
numRepetitionsPerPreambleAttempt=n4, support 2×, and 4×OCC
numRepetitionsPerPreambleAttempt=n8, support 2×, 4×, and 8×OCC
numRepetitionsPerPreambleAttempt=n16, support 2×, 4×, 8×, and 16×OCC
numRepetitionsPerPreambleAttempt=n32, support 2×, 4×, 8×, 16×, and 32×OCC
numRepetitionsPerPreambleAttempt=n64, support 2×, 4×, 8×, 16×, and 32×OCC
numRepetitionsPerPreambleAttempt=n128, support 2×, 4×, 8×, 16×, and 32×OCC

The maximum OCC multiplexing factor may be smaller, e.g. only 8 or 16. The maximum configurable OCC multiplexing factor is determined by the minimum between numRepetitionsPerPreambleAttempt and the maximum OCC multiplexing factor

The OCC length is the same as the multiplexing factor. Thus, a longer OCC is required to support a larger multiplexing factor or multiplexing capability. For example, to support a multiplexing factor of 4, the following code can be reused: [+1, +1][+1, −1] for 2×, [+1, +1, +1, +1][+1, −j, −1, +j][+1, −1, +1, −1][+1, +j, −1, −j].

For an IoT NTN device, the legacy methods are used to determine the NPRACH resource, NPRACH format, and preamble sequence generation, etc. If inter repetition OCC is configured, the UE will pick an OCC index randomly in the set of OCC codes, and apply to the NPRACH repetitions. Each entry in an OCC index is applied on a repetition by bit-width multiplication with the sequence. The OCC multiplexing factor should be smaller or equal to the number of repetitions.

For example, for an OCC factor of 4 and a selected OCC code index 2 with [+1, −j, −1, +j], and the number of repetitions is 16, the first group of repetitions is [rep0, rep1, rep2, rep3] is multiplexed with the OCC indexes and the resulting output is given by [rep0, −j*rep1, −rep2, j*rep3]. The same selected OCC is applied to later groups of repetitions until all repetitions of the NPRACH transmission are included.

The OCC multiplexing may be extended to TN NB-IoT, the inter repetition OCC may be used to provide multiplexing capabilities for TN NB-IoT, especially for devices with a larger number of NPRACH repetitions, e.g. 32 or 64 repetitions. For devices with a small number of NPRACH repetitions, e.g. no repetition or only 2 repetitions with coverage enhancement level 0 (CE0), the inter repetition OCC multiplexing may not be sufficient.

Method 3: OCC Multiplexing on Symbol Groups within and Across Repetitions, Type 3 OCC

Yet in another method, OCC is applied among the random access symbol groups in one or more repetitions. Similar to Method 1, the OCC is applied on each symbol group. Instead of a fixed multiplexing factor in Method 1, the OCC multiplexing factor can be configured with at least 4, e.g. 4, 8, 16, or 32, etc. Depending on the configured OCC multiplexing factor, an OCC can extend to multiple repetitions, e.g. with P=4, and OCC multiplexing factor of 16, the OCC occupies 4 consecutive repetitions. Obviously, the multiplexing factor cannot be higher than the multiplication of the number of repetitions and the number of symbols in a repetition.

For an IoT NTN device, the legacy methods are used to determine the NPRACH resource, NPRACH format, and preamble sequence generation, etc. If an OCC multiplexing is configured, the UE will pick an OCC index randomly in the set of OCC codes, and apply to the symbol groups in one or more NPRACH repetitions. Each entry in an OCC index is applied on a symbol group by bit-width multiplication with the sequence. The same selected OCC is applied until all symbol groups in all repetitions of the NPRACH transmissions are included.

With Method 3, for a larger multiplexing factor, a longer OCC length should be used. A sequence of a single OCC index may be applied to symbol groups in multiple NPRACH repetitions.

### Method 4: Combination of Intra Repetition and Inter Repetition OCC, Type 4 OCC

Yet in another method, OCC is applied among the random access symbol groups in one or more repetitions, and achieved by the combination of intra repetition OCC and inter repetition OCC. The intra repetition OCC and inter repetition OCC can be configured and applied independently or jointly.

If only intra repetition OCC is configured, Method 4 is the same as Method 1. If only inter repetition OCC is configured, Method 4 is the same as Method 2.

In one approach (Approach 1), if both intra repetition OCC and inter repetition OCC are configured, the NTN IoT device will first perform intra repetition OCC as in Method 1 for all NPRACH repetitions. Then apply inter repetition OCC as in Method 2 on the repetitions with intra repetition OCC applied in the first step.

By applying both intra repetition OCC and inter repetition OCC, the resulting multiplexing capacity or multiplexing factor is determined by the multiplication of intra repetition OCC multiplexing factor and the inter repetition OCC multiplexing factor. Thus, the multiplexing capability can be achieved with shorter OCC sequences. For example, a multiplexing factor of 16 can be obtained by an intra repetition OCC multiplexing factor of 4, and an inter repetition OCC multiplexing factor of 4.

With both intra and inter repetition multiplexing, the intra repetition multiplexing factor can be fixed as P, e.g. P=4 for NPRACH format 0 and 1. Only the inter repetition multiplexing factor needs to be configured. The inter repetition multiplexing factor can be configured with 2, 4, 8, etc. to obtain a total of 8, 16, and 32 overall multiplexing factors. In this case, the OCC multiplexing should be performed twice, thus Method 4 is more complicated than single OCC multiplexing.

In order to reduce the complexity of OCC multiplexing, an alternative approach (Approach 2) may be considered to override the intra repetition multiplexing if inter repetition multiplexing is configured. That is, if inter repetition OCC multiplexing is configured, intra repetition OCC multiplexing is disabled even if it is configured. Thus, Method 4 will be the same as Method 2 if both intra repetition OCC multiplexing and inter repetition OCC multiplexing are configured.

Approach 1 can support more flexible OCC multiplexing with two OCC procedures at intra repetition and inter repetition stages respectively. Thus, shorter OCC length can be used especially for the inter repetition multiplexing. For the same multiplexing factor, a common OCC structure can be used for both intra repetition and inter repetition cases.

Furthermore, Approach 1 can support a larger OCC multiplexing factor when the number of repetitions is limited. For example, when extended to TN with low coverage enhancement level, the repetition factor may be only 2. By combining intra repetition OCC with inter repetition OCC, the NPRACH multiplexing capability can be greatly enhanced. On the other hand, Approach 1 is more complicated because two steps of OCC multiplexing are performed.

Comparatively, Approach 2 is simpler, only one OCC multiplexing is performed. However, to achieve a higher multiplexing factor, a longer OCC length should be configured for the inter repetition multiplexing. Thus, it is not as flexible as Approach 1. Furthermore, for NPRACH configured with a small number of repetitions, the multiplexing capability will be very limited as well.

Therefore, Approach 1 and Approach 2 have pros and cons. If only one approach is specified, either Approach 1 or Approach 2 can be selected. A new parameter may be indicated in the NPRACH configuration to indicate the approach to be used. Alternatively and/or additionally, a new parameter with higher layer signaling, e.g. Radio Resource Control (RRC) signaling can be used to indicate which approach should be used in case of both intra repetition OCC multiplexing and inter repetition OCC multiplexing are configured.

Yet in another case, whether Approach 1 or Approach 2 is applied is determined by the number of repetitions numRepetitionsPerPreambleAttempt. If the number of repetitions is small, e.g. less than 4 or 8, Approach 1 is applied to provide higher potential multiplexing capabilities. On the other hand, if the number of repetitions is larger, e.g. greater than 8 or 16, there may be enough multiplexing capability with inter repetition OCC, Approach 2 is used.

Alternatively and/or additionally, whether Approach 1 or Approach 2 is applied may be determined by the CE level of a given NB-IoT UE. For low CE level, e.g. CE0, Approach 1 is used so that intra repetition OCC is applied together with inter repetition OCC if configured to provide more multiplexing capabilities. On the other hand, for CE2 with a large repetition factor, Approach 2 is used since inter repetition OCC may provide enough multiplexing capabilities.

### D. Configurations of OCC Multiplexing for NPRACH

The OCC multiplexing factor for NPRACH can be configured in SIB2 NPRACH configuration, including NPRACH-ConfigSIB-NB, and NPRACH-Parameters-NB etc. Some new parameters may be added depending on the supported OCC multiplexing methods.

### Method 1 OCC Only

If only intra repetition OCC multiplexing is supported as in Method 1, the multiplexing factor may be configurable and selected between 2 and 4 for preamble format 0 and format 1. Thus, a higher layer parameter can be used to indicate the OCC multiplexing factor, e.g.:
numMultiplexingFactor ENUMERATED {n1, n2, n4}

The parameter n1 means no OCC is applied, n2 means OCC multiplexing factor of 2, and n4 means OCC multiplexing factor of 4. Alternatively, no OCC multiplexing if the parameter numMultiplexingFactor is not configured, only n2 and n4 values are valid.

In another alternative, the multiplexing factor may be fixed in Method 1, e.g. 4 for preamble format 0 and format 1. Thus, a higher layer parameter can be used to indicate whether OCC multiplexing is enabled or not, e.g.:
OCCMultiplexing ENUMERATED {enabled, disabled}

### Method 2 OCC Only

If only inter repetition OCC multiplexing is supported as in Method 2, the multiplexing factor may be configurable. Thus, a higher layer parameter can be used to indicate the OCC multiplexing factor, e.g.:
numMultiplexingFactor ENUMERATED {n1, n2, n4, n8, n16, n32}

The parameter n1 means no OCC is applied, n2 means OCC multiplexing factor of 2, n4 means OCC multiplexing factor of 4, n8 means OCC multiplexing factor of 8, n16 means OCC multiplexing factor of 16, and n32 means OCC multiplexing factor of 32.

Alternatively, the multiplexing factor should be at least 4, and no OCC multiplexing if the parameter numMultiplexingFactor is not configured. Thus, the values in the parameter can be reduced and limited to the following:
numMultiplexingFactor ENUMERATED {n4, n8, n16, n32}

### Method 3 OCC Only

If OCC multiplexing is supported among the random access symbol groups in one or more repetitions as in Method 3, the multiplexing factor may be configurable. Thus, a higher layer parameter can be used to indicate the OCC multiplexing factor, e.g.:
numMultiplexingFactor ENUMERATED {n1, n2, n4, n8, n16, n32}

Similar to the above, the parameter n1 means no OCC is applied, n2 means OCC multiplexing factor of 2, n4 means OCC multiplexing factor of 4, n8 means OCC multiplexing factor of 8, n16 means OCC multiplexing factor of 16, and n32 means OCC multiplexing factor of 32.

In some examples, the multiplexing factor should be at least 4, and no OCC multiplexing if the parameter numMultiplexingFactor is not configured. Thus, the values in the parameter can be reduced and limited to the following:
numMultiplexingFactor ENUMERATED {n4, n8, n16, n32}
   Method 4 with Combinations of Intra and Inter Repetition OCCs

If Method 4 is adopted, thus OCC is applied among the random access symbol groups in one or more repetitions, and achieved by the combination of intra repetition OCC and inter repetition OCC. The intra repetition OCC and inter repetition OCC can be configured and applied independently.

For intra repetition OCC multiplexing, a new parameter can be introduced.
intraRepetitionMultiplexingFactor ENUMERATED {n1, n2, n4}

The parameter n1 means no OCC is applied, n2 means OCC multiplexing factor of 2, and n4 means OCC multiplexing factor of 4. Alternatively, no OCC multiplexing if the parameter is not configured, thus, the n1 value can be removed from the valid entries. In another alternative, the multiplexing factor may be fixed, e.g. 4 for preamble format 0 and format 1. Thus, a higher layer parameter can be used to indicate whether intra repetition OCC multiplexing is enabled or not, e.g.:
intraRepetitionMultiplexing ENUMERATED {enabled, disabled}

For inter repetition OCC multiplexing, a new parameter can be introduced.
interRepetitionMultiplexingFactor ENUMERATED {n1, n2, n4, n8, n16, n32}

The parameter n1 means no OCC is applied, n2 means OCC multiplexing factor of 2, and n4 means OCC multiplexing factor of 4, and so on. Alternatively, no OCC multiplexing if the parameter is not configured, thus, the n1 value can be removed from the valid entries.

Alternatively, if the intra repetition multiplexing factor is fixed, a single multiplexing factor is configured for the overall multiplexing factor, the inter repetition OCC multiplexing factor is calculated by the overall multiplexing factor divided by the intra repetition multiplexing.

Yet in another alternative, if the intra repetition multiplexing factor is fixed, a single multiplexing factor is configured for the inter repetition OCC multiplexing factor, and the overall multiplexing factor is calculated by multiplication of the inter repetition OCC multiplexing factor and the intra repetition multiplexing.

In one approach, the intra repetition and inter repetition multiplexing are performed jointly if both are configured. If the maximum multiplexing factor is limited to 32, the intra repetition multiplexing factor may be fixed as 4, and the inter repetition multiplexing factor may be limited to 8.

In another approach, if inter repetition OCC multiplexing is configured, intra repetition OCC multiplexing is disabled even if it is configured. In this case, the valid values for inter repetition multiplexing factor can be 32 to support a maximum multiplexing factor of 32.

Therefore, if only one approach is specified, either Approach 1 or Approach 2 can be selected.

Alternatively and/or additionally, a higher layer signaling, e.g. RRC signaling can be used to indicated which approach should be used in Method 4.

Yet in another alternative, whether Approach 1 or Approach 2 is applied is determined by the number of repetitions numRepetitionsPerPreambleAttempt. A threshold value can be configured or specified in the standard, Approach 1 is used if the number of repetitions is smaller than the threshold, and Approach 2 is applied if the number of repetitions is greater or equal to the threshold.

Alternatively and/or additionally, whether Approach 1 or Approach 2 is applied may be determined by the CE level of a given NB-IoT UE, e.g. for low CE level such as CE0 with no repetition or very small repetitions, Approach 1 is used. On the other hand, for high CE level, e.g. CE2 with a large repetition factor, Approach 2 is used.

UE Behaviors for NPRACH Preamble Transmissions with OCC Multiplexing

An IoT NTN device or an NB-IoT UE may receive NPRACH configurations including with NPRACH resource configuration, repetition parameters, and orthogonal cover code (OCC) multiplexing methods and OCC multiplexing factors, etc.

For contention based random access, the device selects a NPRACH resource and transmits NPRACH preambles with the configured OCC multiplexing method(s) and multiplexing factor(s).

Base Station Behavior with OCC for NPRACH

With OCC multiplexing method and parameters configured, the eNB will detect the NPRACH sequences by hypothesis tests with all OCC codes of the configured multiplexing method, and find whether one or more NPRACH preamble(s) is(are) received. The eNB may determine both the NPRACH index(es) and the OCC index(es) if NPRACH preamble(s) are detected.

With OCC multiplexing for PRACH preamble transmissions, NPRACH collision occurs only if two or more NTN IoT devices transmit NPRACH preambles using the same NPRACH resource (time/frequency location) with the same OCC index. Even if NTN IoT devices select the same NPRACH resource (time/frequency location), if different OCC indexes are used for different IoT devices, the eNB can receive and detect them at the same time. The maximum number of simultaneous NPRACH preambles in a NPRACH resource is given by the OCC multiplexing factor.

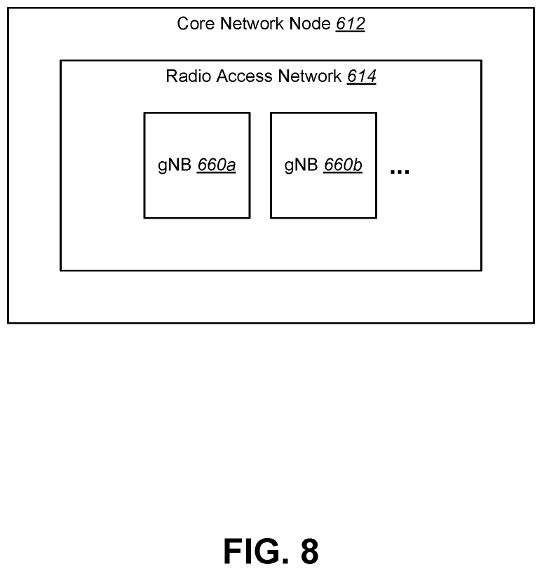

FIG. 8 is block diagram illustrating one implementation of a core network node 612. The core network node 612 may include a radio access network 614 that includes a plurality of gNBs (gNB 660a, 660b). Messages transmitted and received by the core network node 612 may be transmitted and received by the gNBs 660a, 660b in the radio access network 614. The core network node 612 may be part of the 5GC 118 or the NG-RAN 102.

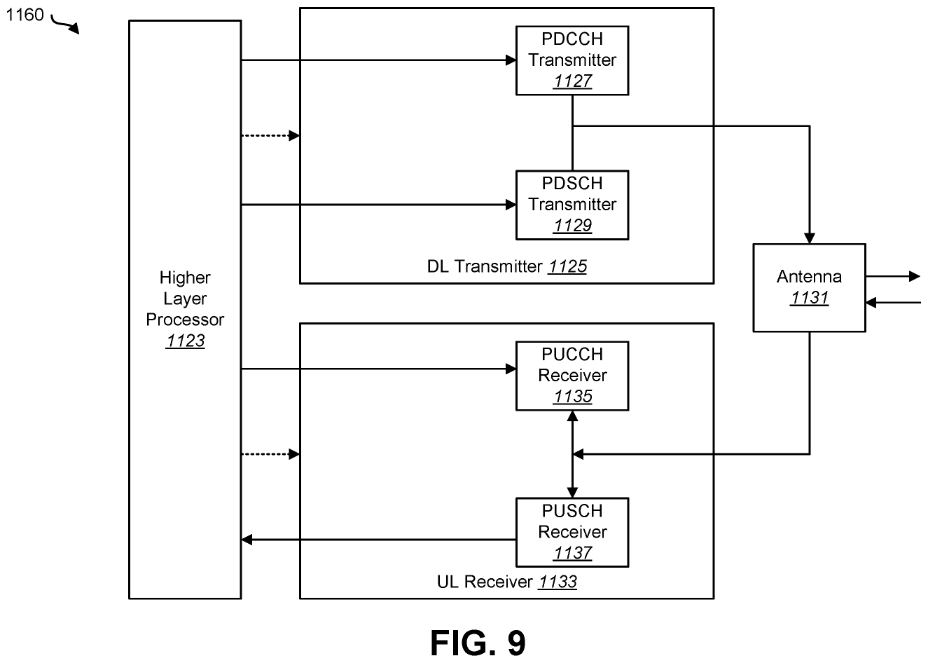

FIG. 9 is a block diagram illustrating one implementation of a gNB 1160. The gNB 1160 may include a higher layer processor 1123, a DL transmitter 1125, a UL receiver 1133, and one or more antenna 1131. The DL transmitter 1125 may include a PDCCH transmitter 1127 and a PDSCH transmitter 1129. The UL receiver 1133 may include a PUCCH receiver 1135 and a PUSCH receiver 1137.

The higher layer processor 1123 may manage physical layer's behaviors (the DL transmitter's and the UL receiver's behaviors) and provide higher layer parameters to the physical layer. The higher layer processor 1123 may obtain transport blocks from the physical layer. The higher layer processor 1123 may send and/or acquire higher layer messages such as an RRC message and MAC message to and/or from a wireless terminal's higher layer. The higher layer processor 1123 may provide the PDSCH transmitter transport blocks and provide the PDCCH transmitter transmission parameters related to the transport blocks.

The DL transmitter 1125 may multiplex downlink physical channels and downlink physical signals (including reservation signal) and transmit them via transmission antennas 1131. The UL receiver 1133 may receive multiplexed uplink physical channels and uplink physical signals via receiving antennas 1131 and de-multiplex them. The PUCCH receiver 1135 may provide the higher layer processor 1123 Uplink Control Information (UCI). The PUSCH receiver 1137 may provide the higher layer processor 1123 received transport blocks.

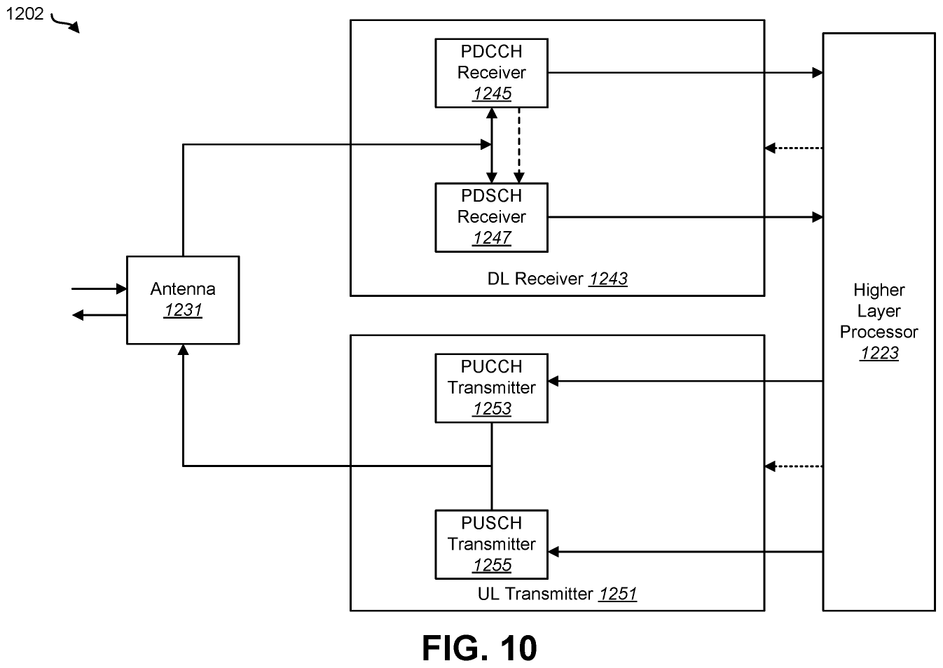

FIG. 10 is a block diagram illustrating one implementation of a wireless terminal 1202. In some examples, the wireless terminal 1202 is a UE. The wireless terminal 1202 may include a higher layer processor 1223, a UL transmitter 1251, a DL receiver 1243, and one or more antenna 1231. The UL transmitter 1251 may include a PUCCH transmitter 1253 and a PUSCH transmitter 1255. The DL receiver 1243 may include a PDCCH receiver 1245 and a PDSCH receiver 1247.

The higher layer processor 1223 may manage physical layer's behaviors (the UL transmitter's and the DL receiver's behaviors) and provide higher layer parameters to the physical layer. The higher layer processor 1223 may obtain transport blocks from the physical layer. The higher layer processor 1223 may send and/or acquire higher layer messages such as an RRC message and MAC message to and/or from a wireless terminal's higher layer. The higher layer processor 1223 may provide the PUSCH transmitter transport blocks and provide the PUCCH transmitter 1253 UCI.

The DL receiver 1243 may receive multiplexed downlink physical channels and downlink physical signals via receiving antennas 1231 and de-multiplex them. The PDCCH receiver 1245 may provide the higher layer processor 1223 DCI (Downlink Control Information). The PDSCH receiver 1247 may provide the higher layer processor 1223 received transport blocks.

It should be noted that names of physical channels described herein are examples. The other names such as “NRPDCCH, NRPDSCH, NRPUCCH and NRPUSCH”, “new Generation-(G)PDCCH, GPDSCH, GPUCCH and GPUSCH” or the like can be used.

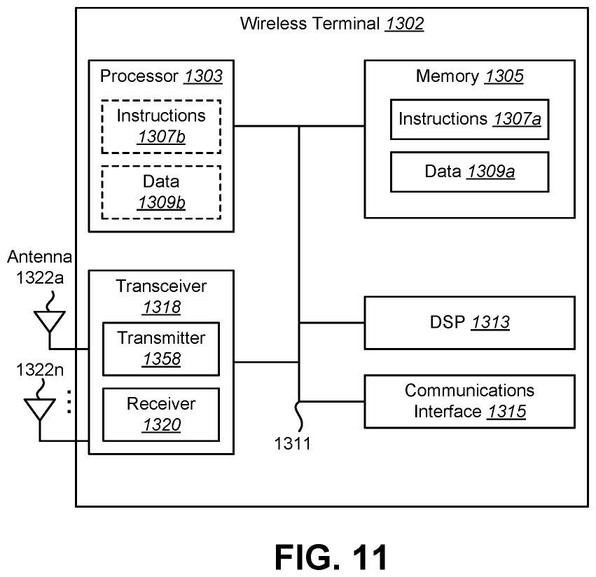

FIG. 11 illustrates various components that may be utilized in a wireless terminal 1302. In some examples, the wireless terminal 1302 is a UE. The wireless terminal 1302 described in connection with FIG. 11 may be implemented in accordance with the wireless terminal described herein. The wireless terminal 1302 includes a processor 1303 that controls operation of the wireless terminal 1302. The processor 1303 may also be referred to as a central processing unit (CPU). Memory 1305, which may include read-only memory (ROM), random access memory (RAM), a combination of the two or any type of device that may store information, provides instructions 1307a and data 1309a to the processor 1303. A portion of the memory 1305 may also include non-volatile random-access memory (NVRAM). Instructions 1307b and data 1309b may also reside in the processor 1303. Instructions 1307b and/or data 1309b loaded into the processor 1303 may also include instructions 1307a and/or data 1309a from memory 1305 that were loaded for execution or processing by the processor 1303. The instructions 1307b may be executed by the processor 1303 to implement the methods described above.

The wireless terminal 1302 may also include a housing that contains one or more transmitters 1358 and one or more receivers 1320 to allow transmission and reception of data. The transmitter(s) 1358 and receiver(s) 1320 may be combined into one or more transceivers 1318. One or more antennas 1322a-n are attached to the housing and electrically coupled to the transceiver 1318.

The various components of the wireless terminal 1302 are coupled together by a bus system 1311, which may include a power bus, a control signal bus and a status signal bus, in addition to a data bus. However, for the sake of clarity, the various buses are illustrated in FIG. 11 as the bus system 1311. The wireless terminal 1302 may also include a digital signal processor (DSP) 1313 for use in processing signals. The wireless terminal 1302 may also include a communications interface 1315 that provides user access to the functions of the wireless terminal 1302. The wireless terminal 1302 illustrated in FIG. 11 is a functional block diagram rather than a listing of specific components.

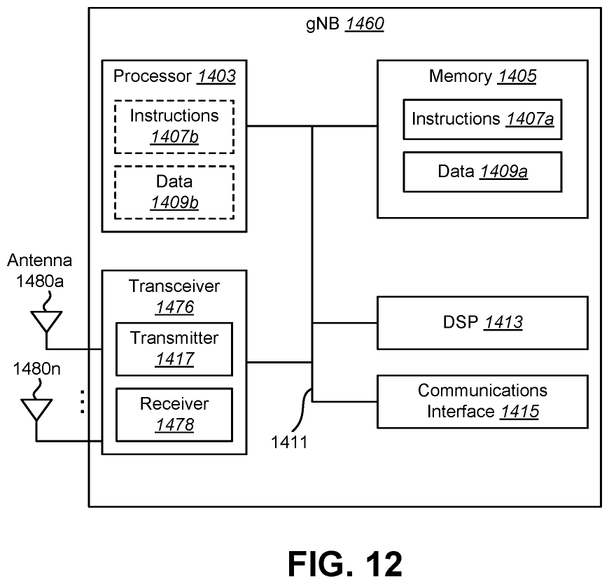

FIG. 12 illustrates various components that may be utilized in a gNB 1460. The gNB 1460 described in connection with FIG. 11 may be implemented in accordance with the gNB described herein. The gNB 1460 includes a processor 1403 that controls operation of the gNB 1460. The processor 1403 may also be referred to as a central processing unit (CPU). Memory 1405, which may include read-only memory (ROM), random access memory (RAM), a combination of the two or any type of device that may store information, provides instructions 1407a and data 1409a to the processor 1403. A portion of the memory 1405 may also include non-volatile random-access memory (NVRAM). Instructions 1407b and data 1409b may also reside in the processor 1403. Instructions 1407b and/or data 1409b loaded into the processor 1403 may also include instructions 1407a and/or data 1409a from memory 1405 that were loaded for execution or processing by the processor 1403. The instructions 1407b may be executed by the processor 1403 to implement the methods described above.

The gNB 1460 may also include a housing that contains one or more transmitters 1417 and one or more receivers 1478 to allow transmission and reception of data. The transmitter(s) 1417 and receiver(s) 1478 may be combined into one or more transceivers 1476. One or more antennas 1480a-n are attached to the housing and electrically coupled to the transceiver 1476.

The various components of the gNB 1460 are coupled together by a bus system 1411, which may include a power bus, a control signal bus and a status signal bus, in addition to a data bus. However, for the sake of clarity, the various buses are illustrated in FIG. 12 as the bus system 1411. The gNB 1460 may also include a digital signal processor (DSP) 1413 for use in processing signals. The gNB 1460 may also include a communications interface 1415 that provides user access to the functions of the gNB 1460. The gNB 1460 illustrated in FIG. 12 is a functional block diagram rather than a listing of specific components.

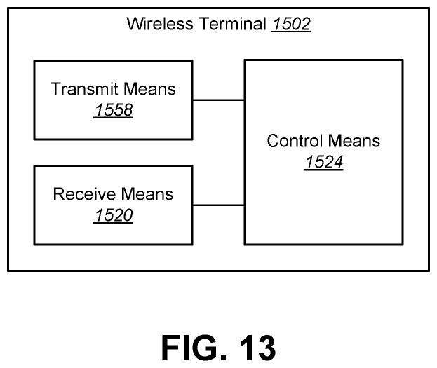

FIG. 13 is a block diagram illustrating one implementation of a wireless terminal 1502 in which systems and methods for resource allocations of enhanced uplink transmissions may be implemented. The wireless terminal 1502 includes transmit means 1558, receive means 1520 and control means 1524. The transmit means 1558, receive means 1520 and control means 1524 may be configured to perform one or more of the functions described herein. FIG. 11 above illustrates one example of a concrete apparatus structure of FIG. 13. Other various structures may be implemented to realize one or more of the functions herein. For example, a DSP may be realized by software.

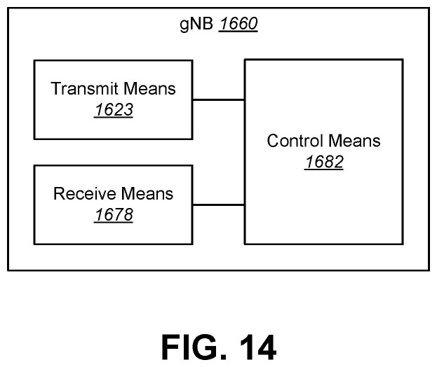

FIG. 14 is a block diagram illustrating one implementation of a gNB 1660 in which systems and methods for resource allocations of enhanced uplink transmissions may be implemented. The gNB 1660 includes transmit means 1623, receive means 1678 and control means 1682. The transmit means 1623, receive means 1678 and control means 1682 may be configured to perform one or more of the functions described herein. FIG. 12 above illustrates one example of a concrete apparatus structure of FIG. 14. Other various structures may be implemented to realize one or more of the functions described herein. For example, a DSP may be realized by software.

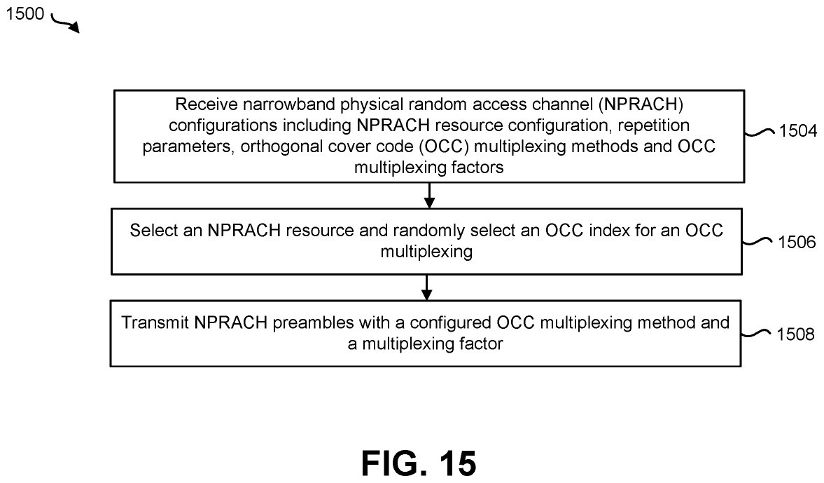

FIG. 15 is a flow diagram illustrating one example of a method 1500 implemented by an IoT NTN device UE. The UE may receive 1504 narrowband physical random access channel (NPRACH) configurations including NPRACH resource configuration, repetition parameters, orthogonal cover code (OCC) multiplexing methods and OCC multiplexing factors. The UE may select 1506 an NPRACH resource and randomly select an OCC index for an OCC multiplexing. The UE may transmit 1508 NPRACH preambles with a configured OCC multiplexing method and a multiplexing factor.

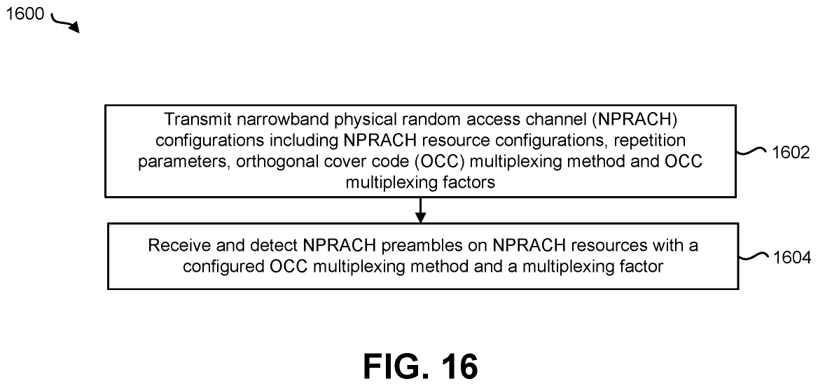

FIG. 16 is a flow diagram illustrating one example of a method 1600 by a base station (gNB). The gNB may transmit 1602 narrowband physical random access channel (NPRACH) configurations including NPRACH resource configurations, repetition parameters, orthogonal cover code (OCC) multiplexing method and OCC multiplexing factors. The gNB may receive and detect 1604 NPRACH preambles on NPRACH resources with a configured OCC multiplexing method and a multiplexing factor.

The term “computer-readable medium” refers to any available medium that can be accessed by a computer or a processor. The term “computer-readable medium,” as used herein, may denote a computer- and/or processor-readable medium that is non-transitory and tangible. By way of example, and not limitation, a computer-readable or processor-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer or processor. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

It should be noted that one or more of the methods described herein may be implemented in and/or performed using hardware. For example, one or more of the methods described herein may be implemented in and/or realized using a chipset, an application-specific integrated circuit (ASIC), a large-scale integrated circuit (LSI) or integrated circuit, etc.

Each of the methods disclosed herein comprises one or more steps or actions for achieving the described method. The method steps and/or actions may be interchanged with one another and/or combined into a single step without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods, and apparatus described herein without departing from the scope of the claims.

A program running on the gNB or the wireless terminal according to the described systems and methods is a program (a program for causing a computer to operate) that controls a CPU and the like in such a manner as to realize the function according to the described systems and methods. Then, the information that is handled in these apparatuses is temporarily stored in a RAM while being processed. Thereafter, the information is stored in various ROMs or Hard Disk Drives (HDDs), and whenever necessary, is read by the CPU to be modified or written. As a recording medium on which the program is stored, among a semiconductor (for example, a ROM, a nonvolatile memory card, and the like), an optical storage medium (for example, a DVD, a MO, a MD, a CD, a BD, and the like), a magnetic storage medium (for example, a magnetic tape, a flexible disk, and the like), and the like, any one may be possible. Furthermore, in some cases, the function according to the described systems and methods described above is realized by running the loaded program, and in addition, the function according to the described systems and methods is realized in conjunction with an operating system or other application programs, based on an instruction from the program.

Furthermore, in a case where the programs are available on the market, the program stored on a portable recording medium can be distributed or the program can be transmitted to a server computer that connects through a network such as the Internet. In this case, a storage device in the server computer also is included. Furthermore, some or all of the gNB and the wireless terminal according to the systems and methods described above may be realized as an LSI that is a typical integrated circuit. Each functional block of the gNB and the wireless terminal may be individually built into a chip, and some or all functional blocks may be integrated into a chip. Furthermore, a technique of the integrated circuit is not limited to the LSI, and an integrated circuit for the functional block may be realized with a dedicated circuit or a general-purpose processor. Furthermore, if with advances in a semiconductor technology, a technology of an integrated circuit that substitutes for the LSI appears, it is also possible to use an integrated circuit to which the technology applies.

Moreover, each functional block or various features of the base station device and the terminal device used in each of the aforementioned implementations may be implemented or executed by a circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

As used herein, the term “and/or” should be interpreted to mean one or more items. For example, the phrase “A, B and/or C” should be interpreted to mean any of: only A, only B, only C, A and B (but not C), B and C (but not A), A and C (but not B), or all of A, B, and C. As used herein, the phrase “at least one of” should be interpreted to mean one or more items. For example, the phrase “at least one of A, B and C” or the phrase “at least one of A, B or C” should be interpreted to mean any of: only A, only B, only C, A and B (but not C), B and C (but not A), A and C (but not B), or all of A, B, and C. As used herein, the phrase “one or more of” should be interpreted to mean one or more items. For example, the phrase “one or more of A, B and C” or the phrase “one or more of A, B or C” should be interpreted to mean any of: only A, only B, only C, A and B (but not C), B and C (but not A), A and C (but not B), or all of A, B, and C.

What is claimed is:

1. An internet of things (IoT) non-terrestrial network (NTN) device user equipment (UE), comprising:
receiving circuitry configured to:
receive narrowband physical random access channel (NPRACH) configurations including orthogonal cover code (OCC) multiplexing factors;
transmitting circuitry configured to:
select an NPRACH resource and randomly select an OCC index for an OCC multiplexing; and
transmit NPRACH preambles with a configured OCC multiplexing factor.

2. The UE of claim 1, wherein intra repetition OCC and inter repetition OCC are configured, and wherein an intra repetition OCC multiplexing factor and an inter repetition OCC multiplexing factor are configured separately or jointly.

3. The UE of claim 2, wherein OCC is first applied among random access symbol groups in each NPRACH repetition with an intra repetition multiplexing factor, and wherein the OCC is then applied among the NPRACH repetitions with an inter multiplexing factor over the repetitions with intra repetition OCC.

4. The UE of claim 2, wherein the inter repetition OCC overrides the intra repetition OCC, and wherein the OCC is applied among the NPRACH repetitions with an inter multiplexing factor only without performing intra repetition OCC multiplexing.

5. The UE of claim 2, wherein the receiving circuitry is further configured to receive a parameter in the NPRACH configurations or in higher layer signaling to determine if the intra repetition OCC is applied together with the inter repetition OCC.

6. The UE of claim 2, wherein a threshold is configured, wherein both the intra repetition OCC and the inter repetition OCC are applied if a number of repetitions is smaller than the threshold, and wherein only the inter repetition OCC is applied if the number of repetitions is greater than or equal to the threshold.

7. A base station (gNB), comprising:
transmitting circuitry configured to:
transmit narrowband physical random access channel (NPRACH) configurations including orthogonal cover code (OCC) multiplexing factors;
receiving circuitry configured to:
receive and detect NPRACH preambles on NPRACH resources with a configured OCC multiplexing factor.

8. The gNB of claim 7, wherein intra repetition OCC and inter repetition OCC are configured, and wherein an intra repetition OCC multiplexing factor and an inter repetition OCC multiplexing factor are configured separately or jointly.

9. The gNB of claim 8, wherein OCC is first applied among random access symbol groups in each NPRACH repetition with an intra repetition multiplexing factor, and wherein the OCC is then applied among the NPRACH repetitions with an inter multiplexing factor over the repetitions with intra repetition OCC.

10. The gNB of claim 8, wherein the inter repetition OCC overrides the intra repetition OCC, and wherein the OCC is applied among the NPRACH repetitions with an inter multiplexing factor only without performing intra repetition OCC multiplexing.

11. The gNB of claim 8, wherein the transmitting circuitry is further configured to include a parameter in the NPRACH configurations or in higher layer signaling to determine if the intra repetition OCC is applied together with the inter repetition OCC.

12. The gNB of claim 8, wherein a threshold is configured, wherein both the intra repetition OCC and the inter repetition OCC are applied if a number of repetitions is smaller than the threshold, and wherein only the inter repetition OCC is applied if the number of repetitions is greater than or equal to the threshold.

13. A method by an internet of things (IoT) non-terrestrial network (NTN) device user equipment (UE), comprising:
receiving narrowband physical random access channel (NPRACH) configurations including orthogonal cover code (OCC) multiplexing factors;
selecting an NPRACH resource and randomly selecting an OCC index for an OCC multiplexing; and
transmitting NPRACH preambles with a configured OCC multiplexing factor.
